(19) United States
(12) Patent Application Publication
(10) Pub. No.: US 2017/0336311 A1
(43) Pub. Date: Nov. 23, 2017

(54) AUTOMATED CAPILLARY VISCOMETER

(71) Applicant: Unchained Labs, Pleasanton, CA (US)

(72) Inventors: John Varni, Los Gatos, CA (US); Thomas McWaid, Santa Cruz, CA (US); Anny Tangkilisan, Redwood Shores, CA (US); John Kirkwood, Los Gatos, CA (US); Barry Wong, San Jose, CA (US); Stephen Lambert, Castro Valley, CA (US)

(21) Appl. No.: 15/670,980

(22) Filed: Aug. 7, 2017

Related U.S. Application Data
(63) Continuation of application No. 13/661,640, filed on Oct. 26, 2012.
(60) Provisional application No. 61/553,631, filed on Oct. 31, 2011.

(51) Int. Cl. G01N 11/08

(52) U.S. Cl. CPC G01N 11/08

(57) ABSTRACT

A measurement apparatus and method for determining a viscosity of a fluid are disclosed. A predetermined pre-fill portion of a sample of the fluid is injected into a capillary at a predetermined flow rate. The pressure differential across the capillary is determined, and the measurement is aborted when the measured pressure is greater than a predetermined maximum pressure. When the measured pressure is less than the predetermined maximum pressure, the remaining portion of the sample is injected into through the capillary. The viscosity of the sample is calculated based on a pressure within the capillary during the injection of the remaining portion of the sample.

### CROSS-REFERENCE TO RELATED APPLICATION

This application claims the benefit of U.S. Provisional Patent Application Ser. No. 61/553,631 entitled “AUTOMATED CAPILLARY VISCOMETER” filed Oct. 31, 2011, the disclosure of which is hereby incorporated by reference in its entirety for all purposes.

### FIELD

The field relates generally to viscosity measurement and, more particularly, to an apparatus and method for the automatic measurement of the viscosity of fluid samples.

BACKGROUND

Pharmaceutical companies are not only concerned with developing therapeutics, but also with creating the easiest and least painful drug administration for the patient. This has led to the development of drugs with higher concentrations, requiring a lower volume of administration to achieve correct dosage. However, higher concentration therapeutics pose new development challenges. One of the most prevalent challenges is the increased likelihood of reaching levels of viscosity that are not viable for commercialization. Accordingly, early drug development screening generally includes a measurement of viscosity as part of assessing potential formulations. Obtaining viscosity measurements is often a slow process that frequently requires large amounts of sample material. As a result, obtaining viscosity measurements generally represents a bottleneck in formulation development. Thus, there exists a need for a more efficient and effective system to measure the viscosities of relatively small samples of fluids.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

Embodiments described herein include a measurement apparatus and method to measure viscosity of a fluid sample with a relatively low sample volume, for both Newtonian and non-Newtonian fluids. These embodiments enable the early assessment of viscosity for a wider range of formulations. In some embodiments, the measurement apparatus includes a High Throughput Viscosity measurement module (HTV) mounted within a core automation platform. The measurement apparatus has been designed to measure low-viscosity (e.g., 1-100 centipoise, cP) samples using very little sample volume (e.g., ˜100 microliters, μL) per measurement. The measurement apparatus includes an integrated washing system to enhance throughput and improve reproducibility. Additionally, the measurement apparatus can measure samples across a broad temperature range, such as 4° C. to 40° C. The high throughput nature of the HTV allows for the exploration of a much broader variety of formulation conditions, while providing a much better understanding of potential challenges. Consequently, a more thorough early assessment of viscosity can minimize risk and potential development/clinical challenges.

In one aspect, a method for determining a viscosity of a fluid includes injecting a predetermined “pre-fill” portion of a sample of a fluid into a capillary at a predetermined flow rate. A pressure differential resulting from the flow of the pre-fill volume through the capillary is measured across the capillary. The measurement is aborted if the measured pressure exceeds a predetermined maximum pressure. When the measured pressure remains less than the predetermined maximum pressure the remaining portion of the sample is injected into the capillary. A viscosity of the sample is calculated based on the pressure differential across the capillary that results while the remaining portion of the sample is injected into the capillary.

In another aspect, a method for determining a viscosity of a fluid includes providing a sample of a fluid and providing a measurement apparatus having a capillary. A portion of the sample is injected into the capillary at a predetermined flow rate. A pressure upstream of the capillary is measured. The viscosity of the sample is calculated based on the measured pressure, the predetermined flow rate, and dimensions of the capillary.

In still another aspect, an automated small volume capillary viscometer includes a dispensing element, a positive displacement tip, an injection port, a capillary, and a pressure sensor. The positive displacement tip is mounted on the dispensing element for aspirating and discharging a fluid sample. The injection port is aligned with the positive displacement tip for accepting the fluid sample discharged from the positive displacement tip. The capillary is connected with the injection port for receiving the fluid sample therethrough from the injection port. The pressure sensor is located between the injection port and the capillary for measuring the pressure generated by a constant flow of the fluid sample through the capillary.

In still another aspect, a measurement apparatus for determining a viscosity of a sample is mountable into an automation platform having a positive displacement tip attached to a dispensing element. The measurement apparatus includes a high throughput viscosity measurement module having an injection port, an antechamber, and a capillary. The antechamber connects the injection port with the capillary. The injection port is sized and shaped to accept the positive displacement tip therein to receive the sample from the positive displacement tip.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a front perspective of one embodiment of a measurement apparatus with a removable High Throughput Viscosity measurement module (HTV);

FIG. 2 is a front perspective of the measurement apparatus in accordance with FIG. 1, with a Positive Displacement Tip (PDT);

FIG. 3 is a front perspective of the measurement apparatus in accordance with FIG. 1 but omitting a side panel;

FIG. 4 is a rear perspective of the measurement apparatus in accordance with FIGS. 1 and 3 but omitting a side panel;

FIG. 5 is a front view of the measurement apparatus in accordance with FIGS. 1, 3, and 4;

FIG. 6 is an exploded rear perspective of the measurement apparatus in accordance with FIGS. 1 and 3-5 showing the HTV removed from the measurement apparatus;

FIG. 7 is an exploded front perspective of the measurement apparatus in accordance with FIGS. 1 and 3-6 showing the HTV removed from the measurement apparatus;

FIG. 8 is a rear perspective of the HTV;

FIG. 9 is a cross-section Of the HTV taken along 9-9 of FIG. 8;

FIG. 10 is a cross-section of the HTV taken along 9-9 of FIG. 8 with a PDT inserted;

FIG. 11 is a cross-section of the HTV taken along line 11-11 of FIG. 8;

FIG. 12 is a gross-section of the HTV taken along line 12-12 of FIG. 8 showing a first step of a wash cycle;

FIG. 13 is a cross-section of the HTV along line 12-12 of FIG. 8, showing a second step of a wash cycle;

FIG. 14 is a cross-section of a portion of the HTV taken along line 9-9 of FIG. 8, with the PDT inserted;

FIG. 15 is a block diagram of an exemplary measurement apparatus including an HTV;

FIG. 16 is a flowchart of one embodiment of a method for determining the viscosity of a fluid;

FIG. 17 is a graph plotting measured BSA solution viscosity versus concentration based on an experiment; and

FIG. 18 is a graph plotting viscosity versus shear rate for two sample fluids.

Corresponding reference characters indicate corresponding parts throughout the several views of the drawings.

### DETAILED DESCRIPTION

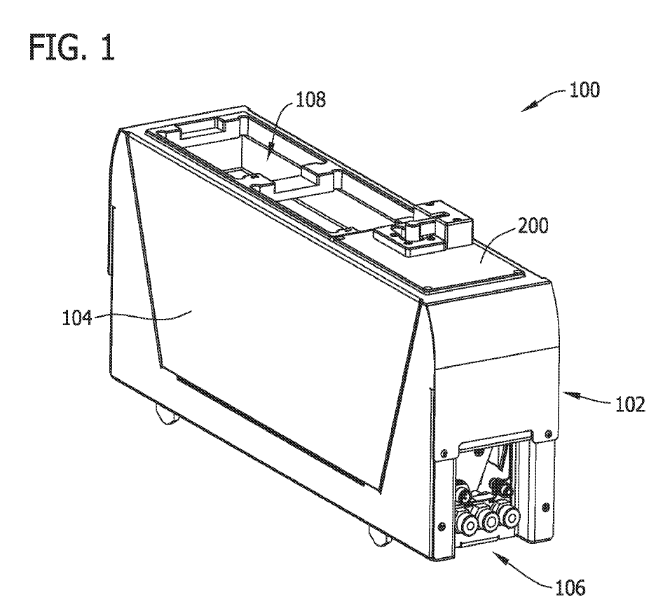

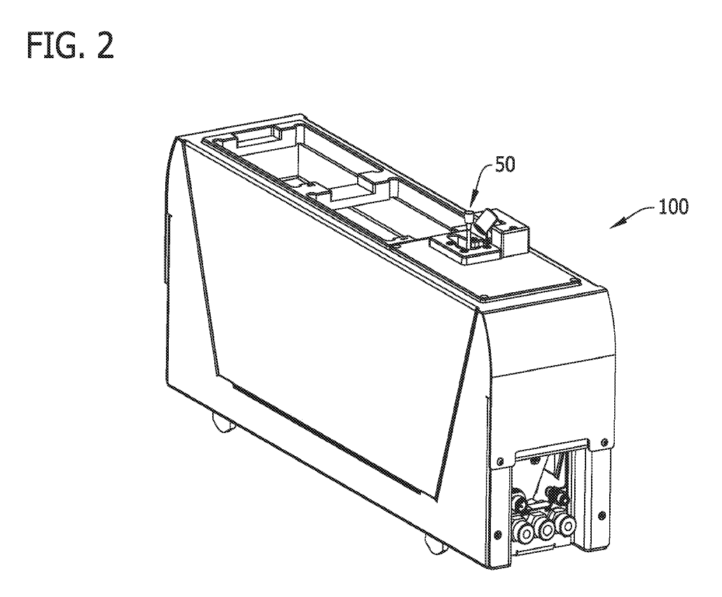

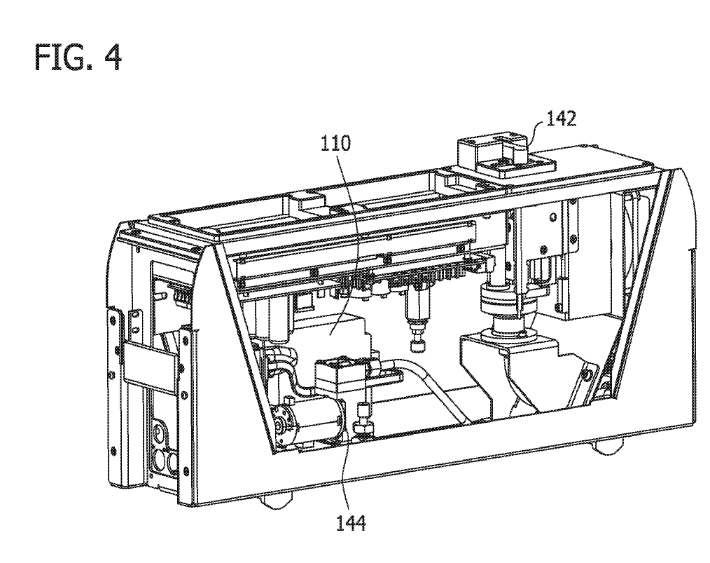

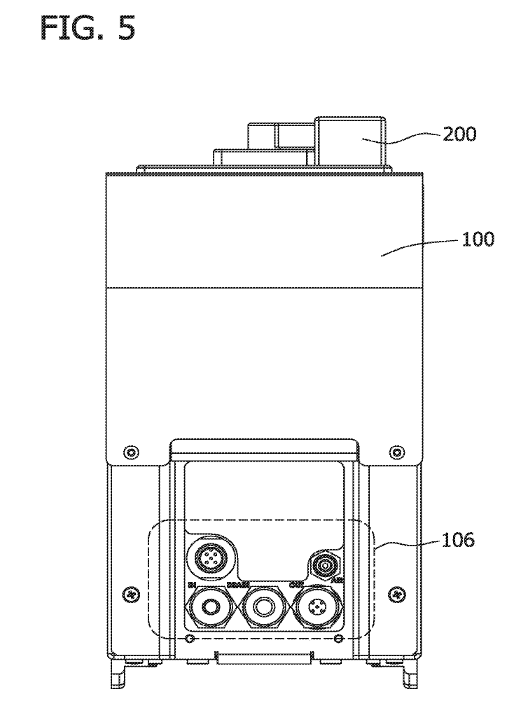

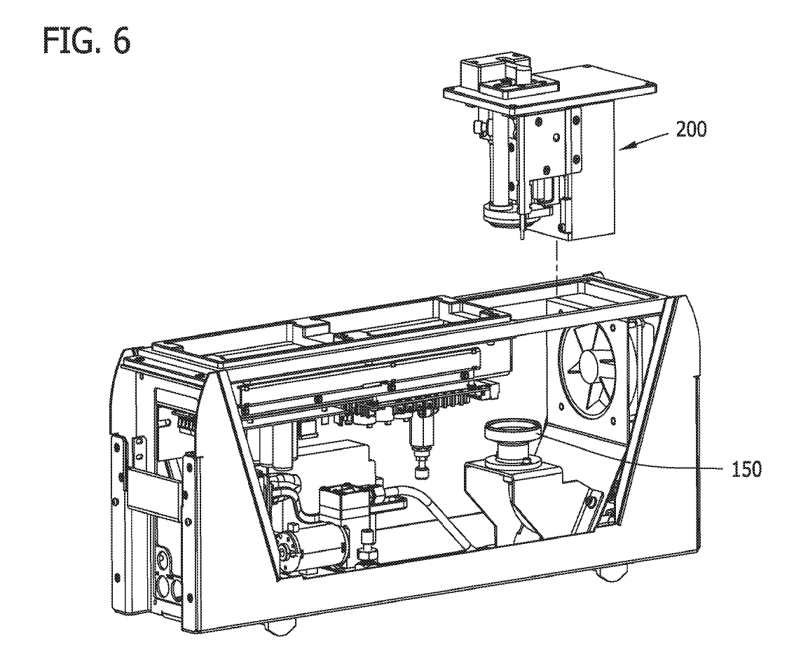

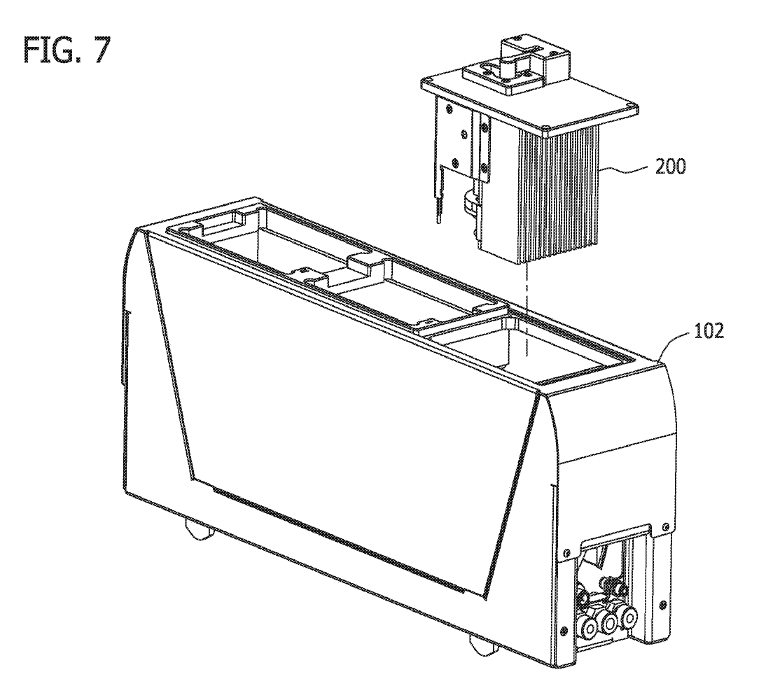

Referring to FIGS. 1-7, measurement apparatus of one embodiment is indicated generally at 100. The measurement apparatus 100 is removably mounted into Freeslate's Core Module 3 (CM3) automation platform (not shown for clarity). More information regarding the CM3 can be found in U.S. Pat. No. 7,848,848 which is incorporated herein in its entirety. The CM3 includes an arm module (not shown for clang which may also include a dispensing element (not shown for clarity). A Positive Displacement Tip (PDT) 50 is mounted to the dispensing element of the CM3.

The measurement apparatus is generally operable to determine the viscosity of fluid provided in the form of multiple samples. The measurement apparatus 100 provides the automated measurement of a group or array of very small volume samples, with as little as 100 μl of a sample, reducing the time and sample volume needed to test viscosity. The automated measurement of the samples provides rapid and sequential results.

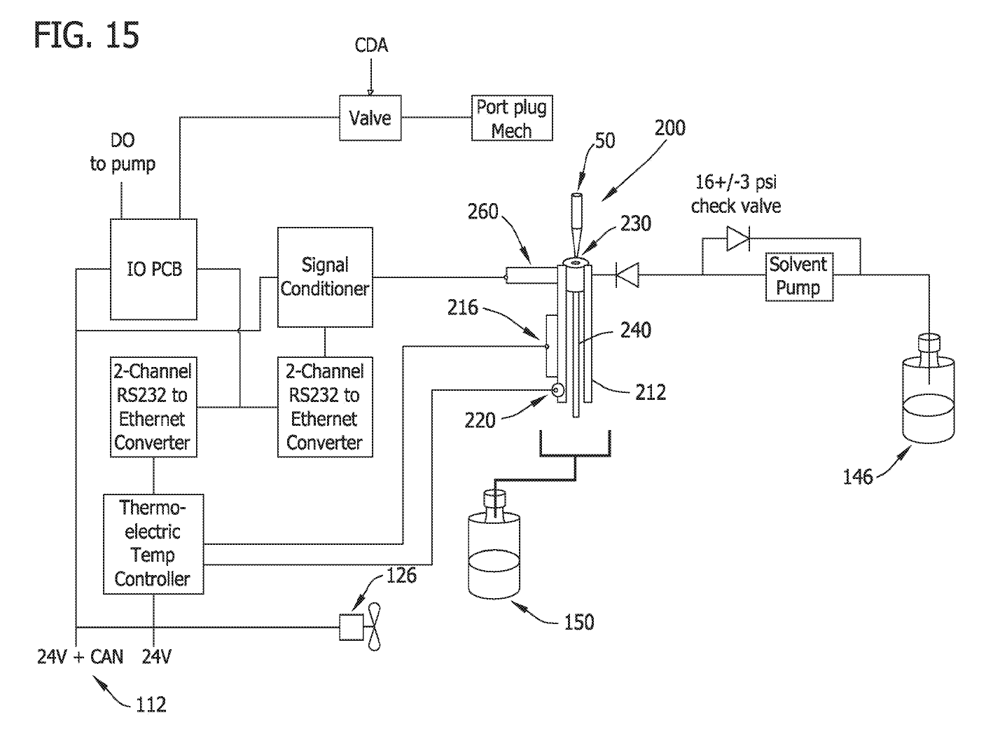

The measurement apparatus 100 generally includes a housing 102 having a cover 104 and connectors (Inlets/Outlets) 106 along a portion thereof, a PDT rack 108, and a High Throughput Viscosity measurement module (HTV) 200. A block diagram of the measurement system 100 is shown in FIG. 15.

The HTV 200 is connected with a processor of a computer system through a signal conditioner 110, a power source 112, a first portion 122 of a temperature control system 120, an integrated wash system 140, and a waste receptacle 150 located within housing 102 of measurement apparatus 100 that may be connected with a waste vessel located outside of the housing. Note that the power source may form a portion of the CM3. The first portion 122 of the temperature control system 120 includes a thermoelectric temperature controller 124 and a thermoelectric heat sink fan 126. A second portion 210 of the temperature control system 120 is located within the HTV 200 and will be discussed below. Both the signal conditioner 110 and the temperature control system 120 are communicate with an Ethernet to RS-232 converter, which is connected with an Ethernet connection back to the control system and to a CAN network.

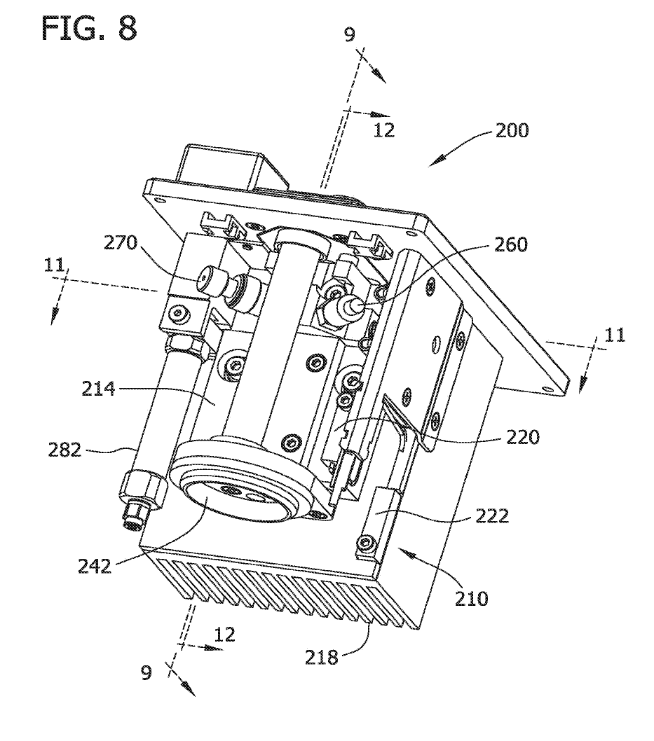

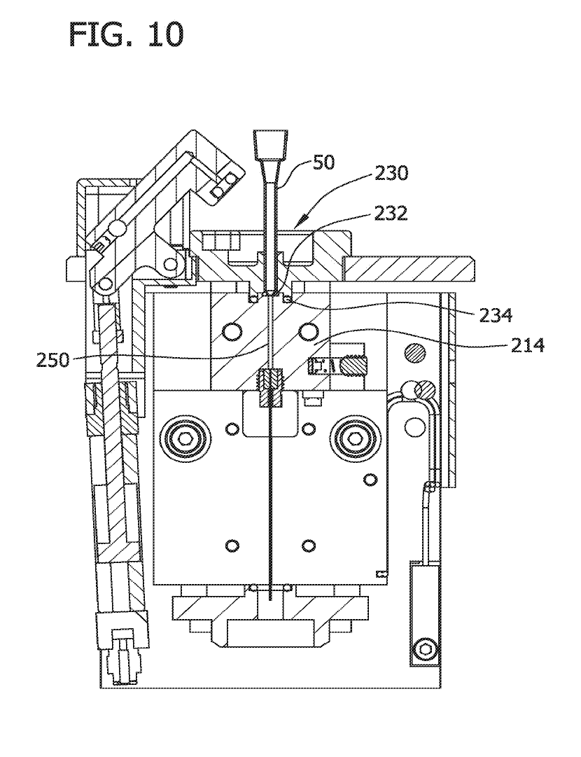

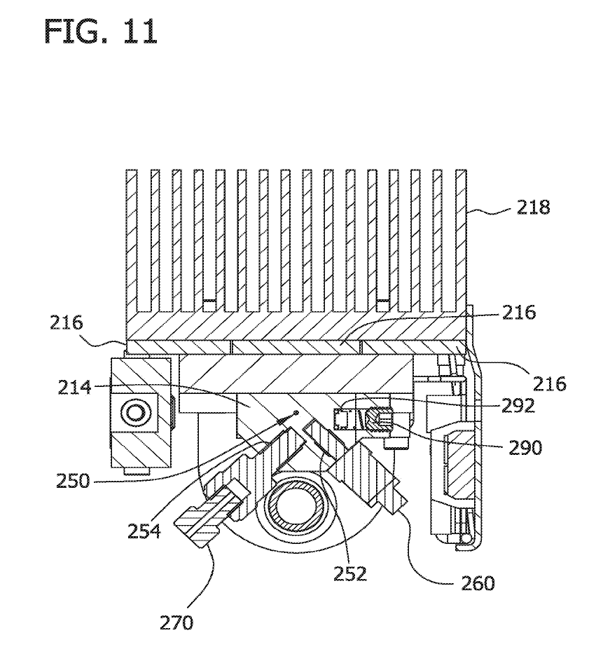

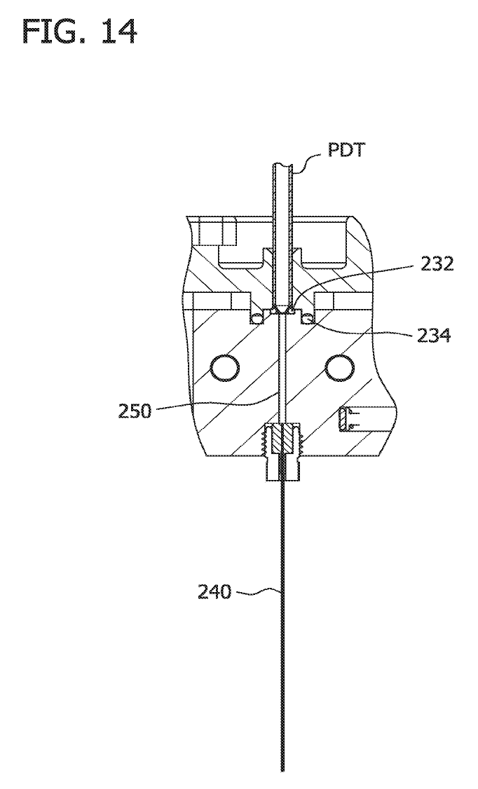

With reference to FIGS. 8-14, the HTV 200 includes an injection port 230 connected with a capillary 240 through an antechamber 250. The antechamber 250 is connected with a pressure sensor/transducer 260 and a wash-check valve 270 through a pressure port 252 and a wash port 254, respectively.

The injection port 230 is sized and shaped to accept PDT 50 of the dispensing clement therein. The PDT 50 is used to inject samples into and through the measurement apparatus 100. The HTV 200 has a first O-ring seal 232 to prevent leakage during the injection of the sample and a second O-ring seal 234 to prevent leakage during washing. The PDT 50 is configured to aspirate relatively viscous samples and to dispense samples at a controlled flow rate. As the samples are dispensed from the PDT 50, the samples are injected into injection port 230 and through HTV 200.

In some embodiments, a plurality of PDTs can be automatically loaded onto, and discarded from, the dispensing element. The use of disposable PDTs reduces the possibility of carry over and makes cleaning the dispensing element between measurements unnecessary. Thus, the rate at which measurements can be obtained, referred to as measurement throughput, is increased.

To determine viscosity of the sample the pressure differential across the capillary is needed. The exit of the capillary 240 is at ambient pressure. Therefore, the pressure upstream of the capillary 240 must be measured to determine the pressure differential. In this embodiment, the pressure sensor 260 is a “gauge” sensor and references the pressure reading to that of ambient pressure. As a result, the pressure differential across the capillary is being determined.

The pressure sensor 260 measures the pressure generated upstream of the capillary 240, during a constant flow of the sample through capillary, and generates a corresponding voltage output. The voltage output from the pressure sensor 260 is sent to the signal conditioner 110, which conditions the signal. The conditioned signal is supplied to and read by the processor of the system computer. The system computer uses the conditioned signal to compute the sample's viscosity. The capillary 240 can easily be swapped with another capillary 240 of a different internal diameter to match the performance of pressure sensor 260 and PDT 50 dispensing element with the viscosity range of the samples.

The principle and structure of capillary viscometers are simple and well known in the art. It is also well known, the inside of a capillary must be kept very clean to obtain accurate measurements. Generally, the capillary must be cleaned, rinsed, and dried before each measurement. The typical process includes passing a cleaning liquid, such as benzene, through, the capillary followed by another cleansing with acetone, and then rinsing the capillary with purified water. The capillary is then left to thoroughly dry before attempting the next measurement.

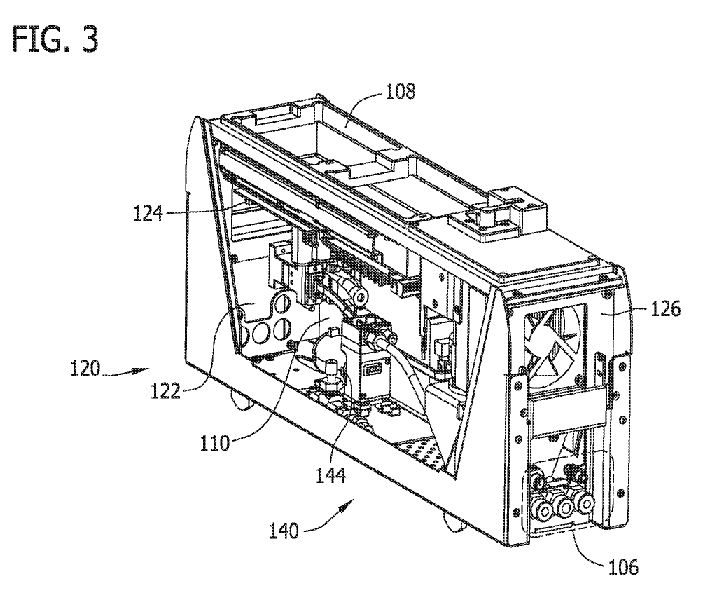

Additionally referring to FIGS. 3, 4, 12, 13 and 15, the integrated wash system 140 is automated to increase the speed at which HTV 200 is cleaned between measurements. The wash system 140 is connected to HTV 200 through wash-check valve 270 and includes a port plug 142, a pump 144, and a reservoir 146 of wash solvent, which may be water for samples that are aqueous.

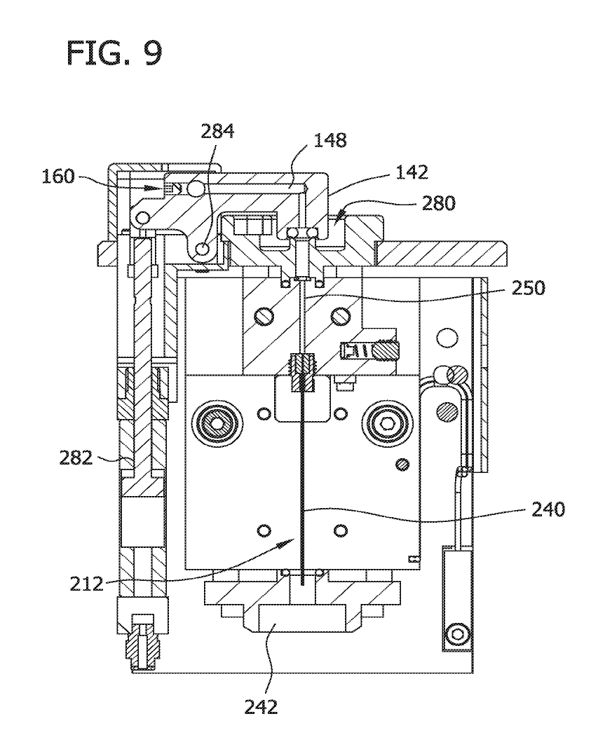

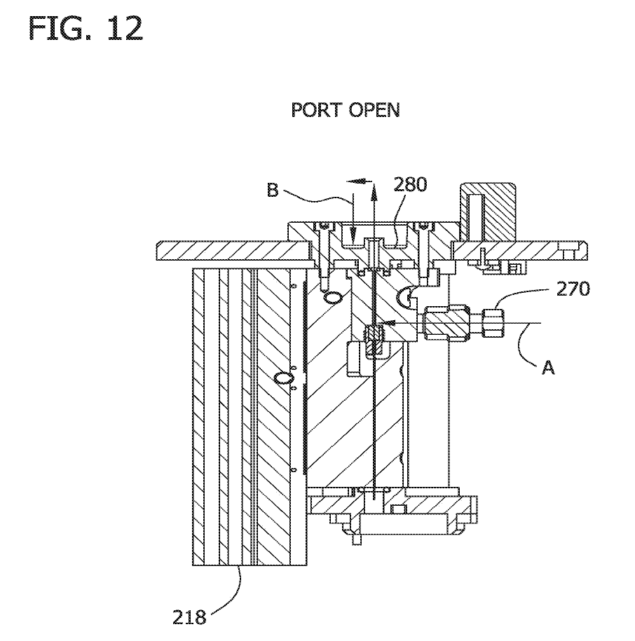

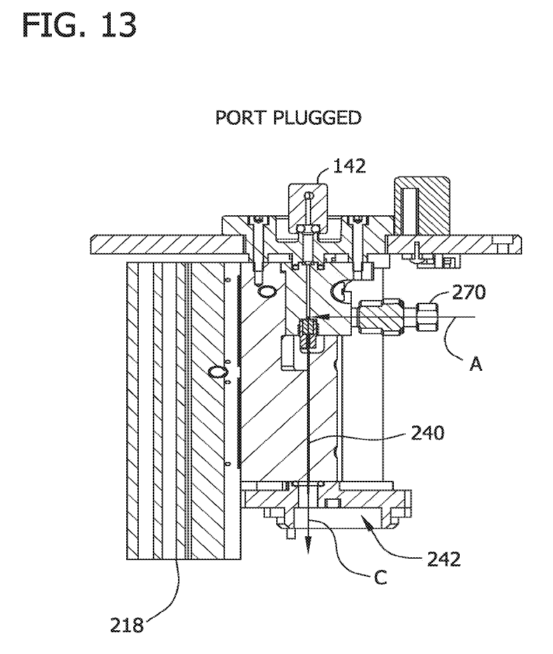

Referring to FIGS. 12 and 13, the wash system 140 cleans HTV 200 in a two-step wash cycle. First, the injection port 230 is cleaned by forcing wash solvent into HTV 200 along arrow A and to flow up through antechamber 250 and out of injection port 230. During this first step of the wash cycle, the expelled wash solvent flows through an overflow pathway into waste receptacle 150. Second, as shown in FIG. 9, an actuator 282 drives upward to cause the port plug 142 to pivot about hinge 284 and to place the port plug 142 in a closed position over the injector port 230. As shown in FIG. 13, the wash solvent is forced into HTV 200 along arrow A and down through capillary 240 and out of a drain 242 along arrow C and into waste receptacle 150.

In some embodiments, the measurement apparatus 100 includes a source of pressurized air 160. In these embodiments, the internal surfaces of HTV 200 are dried by injecting air through HTV 200. The port plug 142 may include an internal air passage 148 that is connected to the source of air 160. The internal air passage 148 aligns with injection port 230 when port plug 142 is located in a closed position over injection port 230. As the air passes through HTV 200, the internal surfaces of HTV 200 are dried.

In other embodiments, a negative pressure formed within measurement apparatus 100 forces air in through the injection port 230 to dry the internal surfaces of HTV 200. Forcing air through HTV 200 causes the evacuation of the wash solvent from within capillary 240 to prevent a subsequent sample from being diluted by the wash solvent.

In addition to being clean, the temperatures of both the capillary and the sample must be controlled to obtain accurate measurements because the internal diameter of the capillary changes as the temperature changes. Any change in the dimensions of the capillary may introduce errors into the viscosity measurement. Similarly, the viscosity of most materials is temperature-dependent. Variations in temperature of the sample may therefore drive changes in sample viscosity.

The temperature control system 120 is capable of precisely controlling the internal surface temperatures of HTV 200 that come into contact with the sample, as well as equilibrating the sample temperature during flow, across the full range of flow rates. Thus, ambient temperature samples may be introduced into the viscometer and the viscosity at various temperatures may be determined, e.g., at temperatures between about 4° and 40° C. in one embodiment. To control the temperature of capillary 240 and the sample, the HTV 200 includes the second portion 210 of temperature control system 120. The second portion 210 of temperature control system 120 is connected with the first portion 122 and includes a copper jacket 212 about capillary 240 and a thermoplate 214 that defines antechamber 250 therethrough. The antechamber 250 is located upstream of capillary 240 to allow samples to thermally equilibrate. The antechamber 250 holds a volume of sample, approximately 2-5 μl. The antechamber 250 acts as an in-line heater/chiller to bring the sample into thermal equilibrium with the internal contact surfaces of HTV 200.

The second portion 210 of temperature control system 120 also includes a thermoelectric assembly 216, a heat sink 218, a control thermistor 220, and thermistor 222 used to avoid an over-temperature condition. The heat sink may be constructed of aluminum. The control thermistor 220 is located along thermoplate 214, which is adjacent to thermoelectric assembly 216. The heat sink 218 and over-temperature thermistor 222 are thermally coupled to the opposite side of the thermoelectric assembly 216.

The control thermistor 220 measures the temperature of thermoplate 214. The thermoelectric controller 124 calculates a temperature using an output of the control thermistor. Then the thermoelectric controller 124 calculates and supplies the heating or cooling power to the thermoelectric assembly 216 that is required to reach or maintain the preselected set point temperature. The heat sink fan 126 moves air across the heat sink 218 to dissipate heat for regulating the temperature of thermoplate 214 and the thermoelectric assembly 216. The over-temperature thermistor 222 is used by the thermoelectric controller 124 in order to prevent the temperature control system 120 from overheating in the event of heat sink fan failure.

In some embodiments, the HTV 200 includes a pressure relief valve 290 to protect pressure sensor 260 from being damaged when capillary 240 becomes plugged or when the sample has a much higher viscosity than expected. A relief passage extends from pressure port 252 to a spring loaded poppet 292 that opens at a predetermined pressure. In these embodiments, the spring loaded poppet acts as the pressure relief valve 290 to prevent damage to pressure sensor 260 by opening to relieve pressure within HTV 200.

In operation, the PDT 50 injects the sample into and through HTV 200. The sample passes through injection port 230 and into antechamber 250 where the temperature of the sample comes into equilibrium with the temperature of capillary 240. The sample is then passed from within antechamber 250 through capillary 240 and into waste receptacle 150. As the sample passes through capillary 240, the pressure is measured and a pressure signal is sent first to the signal conditioner 110 for conditioning, and then to the processor of the system computer for calculating the viscosity of the sample.

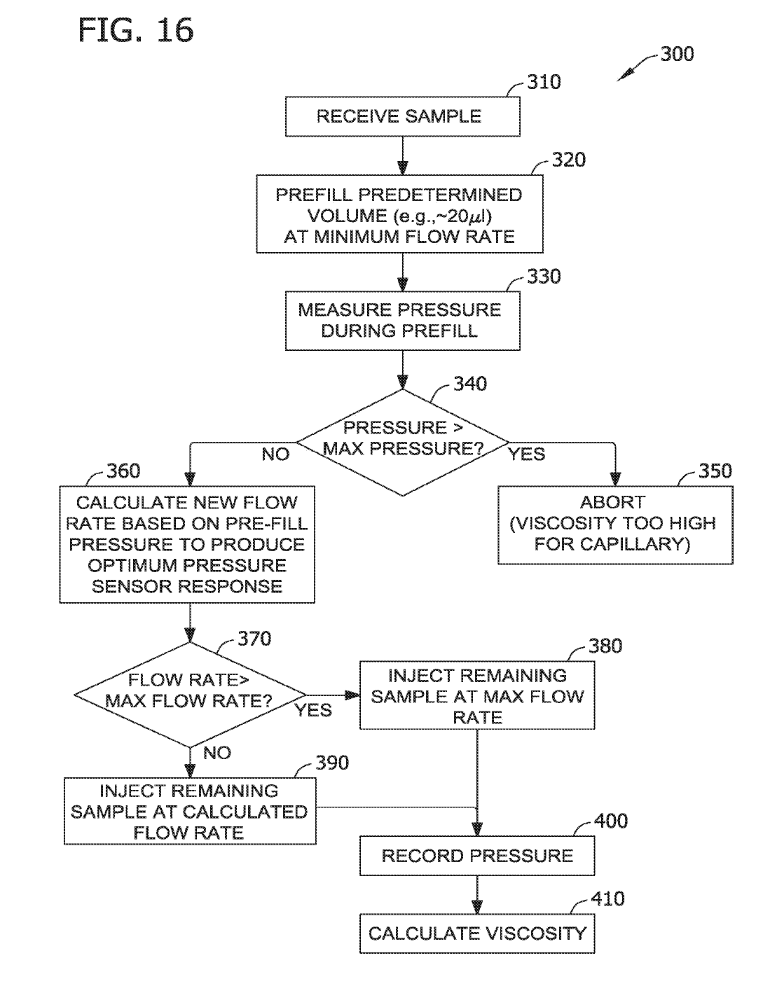

A flow chart of an exemplary method 300 for measuring the viscosity of a fluid is shown in FIG. 16. The method includes several novel data acquisition processes. One such novel process protects the pressure sensor. Since pressure sensors function over a finite range of pressures, injecting a sample at too high of a flow rate may damage the pressure sensor. Therefore, the question of what flow rate to use is significant.

Some embodiments of the HTV use a twin-step or “boot-strapping” princess to determine an appropriate pressure range to prevent damaging the pressure sensor. Although the exact viscosity of the sample is not known, the operator may reasonably predict an expected viscosity range for the sample. During the first step of the “boot strapping” process, a pre-fill portion of the sample (e.g., 10 μl, 20 μl, or 30 μl), forming an initial sample 320, is injected through the capillary at a minimum flow rate 310 that will not create a pressure in excess of the limit of the pressure sensor based on the highest expected viscosity of the sample. The pressure resulting from the injection of the initial sample is measured 330 and it is determined if the measured pressure exceeds the predetermined safe pressure 340. If the measured pressure exceeds the maximum pressure, the process is aborted because the sample's viscosity is too high for the capillary size and damage the pressure sensor 350. If the measured pressure does not exceed maximum pressure, the measured pressure is used to calculate the optimum flow rate (or range of flow rates) that will provide a definite, measurable pressure 360. Then it is determined if the calculated flow rate exceeds the maximum flow rate 370 that is deliverable by the PDT. If the calculated flow rate is greater than the maximum deliverable flow rate, the balance of the sample is then injected through the capillary at the maximum flow rate 380 and the pressure is measured 400. If the calculated flow rate is less than the maximum flow rate, the balance of the sample is then injected through the capillary at the calculated flow rate 390 and the pressure is measured 400. The measured pressure is then used to calculate the viscosity of the sample 410.

In addition, the initial sample wets the dry internal surfaces and flushes any remnants of the wash solvent and/or previous sample from the capillary.

The specific flow rate (shear rate) used in the measurement of the viscosity of a Newtonian liquid is not important as long as the flow of sample through the capillary produces a definite, measurable pressure. The viscosity of Newtonian fluids flowing through a capillary is calculated as the ratio of the shear stress at the capillary wall to the shear rate of the fluid at the wall, as shown in Equation 1.

$$μ = \frac{{τ}_{w}}{\dot{γ}} \qquad ( Eq . 1 )$$

Regardless of fluid type, the shear stress at the wall (assuming no slip) is given Equation 2.

$${τ}_{w} = \frac{R Δ P}{2 L} \qquad ( Eq . 2 )$$

In Equation 2, R and L represent the radius and length of the capillary, respectively,and ΔP represents the pressure drop along the capillary.

For a Newtonian liquid, the shear rite at the wall is given by Equation 3.

$$\dot{γ} = \frac{4 Q}{π {R}^{3}} \qquad ( Eq . 3 )$$

In Equation 3, Q represents the volumetric flow rate. Inserting the equations for shear stress (Equation 2) and shear rate (Equation 3) into the viscosity equation (Equation 1) results in Equation 4.

$$μ = \frac{π {R}^{4} Δ P}{8 LQ} \qquad ( Eq . 4 )$$

As a result, the viscosity of Newtonian fluids is calculated bye the processor using the radius and length of the capillary, the pressure drop, and volumetric flow rate of the sample.

The measurement apparatus is also capable of measuring the viscosity of non-Newtonian fluids. In the context of a non-Newtonian fluid, measurements are made across a range of shear rates, requiring an increase in the total sample volume. If the sample is non-Newtonian or a measurement goal is to ascertain whether or not the sample is non-Newtonian, the user will want to make measurements over a broad range of flow rates (shear rates). In this case, the measurement apparatus can use the pressure developed during the initial sample injection to estimate the minimum and maximum flow rates based upon the dynamic range of the pressure sensor and the capabilities of the PDT dispense element. These estimates can be improved as the flow rate is stepped up from the minimum value; making the PDT and dispensing element very well-suited for providing a range of controlled flow rates.

The resultant data can be used directly to de ether or not the liquid is Newtonian or not. The viscosity of non-Newtonian fluids will vary with flow rate. If a liquid is found to be non-Newtonian and its viscosity needs to be measured as a function of shear rate, then the Weissenberg-Rabinowitsch (WR) correction factor is determined and applied.

The WR correction factor is used to calculate the actual shear rate from the apparent (Newtonian) shear rate. The WR correction factor is calculated from a plot of ln(\dot{γ}) versus ln(τ_{w})). If the plot of the data is linear, a first-order regression analysis provides the slope of the line. That slope corresponds to the WR correction factor. If the relationship is not linear, the data can be fit using a higher order polynomial. In this case, the WR correction factor will vary with shear rate. Regardless of whether the WR is constant or varies with shear rate, once the WR correction factor has been determined, the actual shear rate is calculated from the apparent (Newtonian) shear rate using Equation 5.

$${\dot{γ}}_{a} = \dot{γ} \frac{1}{4} [ 3 + \frac{d ln \dot{γ}}{d ln {τ}_{w}} ] \qquad ( Eq . 5 )$$

viscosity at any particular shear rate is be calculated as the ratio of the shear stress at the capillary wall to the actual shear rate, as shown in Equation 6.

$$μ = \frac{{τ}_{w}}{{\dot{γ}}_{a}} \qquad ( Eq . 6 )$$

### Experimental Results

Bovine Serum Albumin (BSA) solutions are often used as a model protein for analytical instruments allowing for comparisons across instruments. As discussed below, BSA formulations were used to demonstrate the throughput, range, and resolution of the measurement apparatus.

For this study, BSA (available from Sigma-Aldrich) was dissolved in two different PBS (Phosphate Buffered Saline) based buffer solutions. One PBS buffer solution contained 0.01 mM PBS+0.6% Tween 80; the second buffer solution contained 0.01 mM PBS+0.6% Tween 80+10% Sucrose. PBS is a buffer that is commonly used in biological research. The addition of Tween 80 and Sucrose increases the viscosity of the buffer solution. Each of these buffer solutions were filtered, using a NALGENE® filter with a 0.3 μm filter pore size. The BSA was dissolved in the buffer solutions to create 200 mg/mL stock formulations. The BSA formulations were diluted without further filtering to create samples with the following BSA compositions: 20, 50, and 100 mg/mL.

The following measurement procedure was performed.

1) Sample vials were loaded into a microliter plate and placed on Freeslate CM3 deck element maintained at 20° C.

2) For each measurement, 100 μL of the sample aspirated by the PDT and dispensed directly into the HTV module at a controlled flow rate.

3) The capillary temperature was controlled at 20° C.

4) The pressure drop across the capillary was measured.

5) The viscosity of liquid flowing through the capillary was calculated as the ratio of the shear stress at the capillary wall to the shear rate of the fluid at the wall.

6) After each measurement, an automated internal ashing procedure was used to clean the system prior to injecting the next sample.

The measured viscosities of the two BSA buffered compositions are summarized in Table 1 below. The relative standard deviation is less than 3% for each measurement, repeated in triplicate.

TABLE 1

| | BSA in PBS + | | BSA in PBS + 0.6% | |
|---|---|---|---|---|
| BSA | 0.6% Tween 80 | | Tween 80 + | |
| concentration | Ave Viscosity | | 10% Sucrose | |
| (mg/mL) | (cP) | % RSD | Ave. Viscosity (cP) | % RSD |
| 0 | 1.22 | 0.1% | 1.65 | 1.4% |
| 2 | 1.29 | 2.5% | 1.75 | 1.0% |
| 20 | 1.39 | 1.5% | 1.86 | 2.0% |
| 50 | 1.59 | 1.7% | 2.20 | 1.6% |
| 100 | 2.18 | 0.6% | 3.17 | 1.9% |
| 150 | 3.16 | 1.0% | 4.71 | 0.7% |
| 200 | 5.03 | 0.5% | 7.70 | 0.5% |

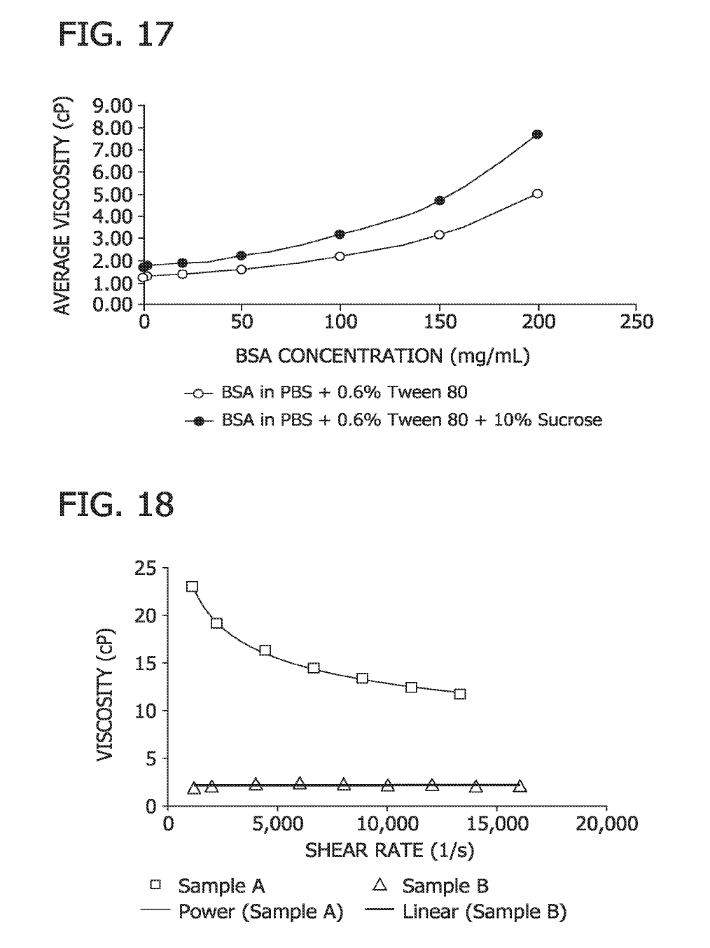

FIG. 17 is a graph plotting the viscosity of the BSA compositions versus concentration for the experiment described above.

Another experiment was conducted to understand the capabilities of the measurement apparatus for distinguishing Newtonian and non-Newtonian fluids and for determining viscosity in non-Newtonian fluids. Specifically, the measurement system was used to measure the viscosity of two commercial eye re-wetting drops, Allergan's REFRESH LIQUIGEL® and REFRESH TEARS®.

The viscosities of Sample A, REFRESH LIQUIGEL®, and Sample B, REFRESH TEARS®, were measured across a range of flow rates varying from approximately 1 μL/s to 15 μL/s, which correspond to shear rates varying from approximately 1000 s⁻¹ to 15,000 s⁻¹.

The viscosity of the REFRESH TEARS® product did not change appreciably across this range of shear rates. Therefore, REFRESH TEARS® is a Newtonian fluid across the range of shear rates over which its viscosity was measured. Conversely, the viscosity of the REFRESH LIQUIGEL® product decreased by more than a factor of two across the applied range of shear rates. Therefore, REFRESH LIQUIGEL® is a non-Newtonian, shear-thinning, liquid.

In order to properly analyze the data obtained for the REFRESH LIQUIGEL® product, the WR correction factor was determined, and then applied to each measurement. The actual (corrected) shear rate was then used to calculate viscosity. FIG. 18 is a graph plotting viscosity versus shear rate for REFRESH LIQUIGEL® and REFRESH TEARS® based on the experiment results described above.

Yet another experiment was performed to evaluate the accuracy of the measurement apparatus with respect to various viscosity standards. Four commercial Newtonian viscosity standards, ranging from 0.92 cP to 92 cP at 20° C., are used to determine the capillary diameter. The pressure resulting from a controlled injection of each standard was measured five times. The averages of each set of five pressure measurements were then plotted against the true viscosity standard values, and a linear least squared fit was performed. Measurement results for these standards, obtained at 20° C. are shown in Table 2.

TABLE 2

| | | | | | Sample | | | |
|---|---|---|---|---|---|---|---|---|
| VisStd | Flow Rate | Temp | Viscosity | Baseline P | Interval | Ave Vis | | Error |
| [cP] | [ul/s] | [C.] | [cP] | [psi] | [ms] | [cP] | % RSD | [cP] |
| 0.9209 | 30 | 20 | 0.9425 | 15.78 | 125 | 0.9298 | 3.07% | 0.0089 |
| | 30 | 19.99 | 0.9498 | 15.78 | 125 | | | |
| | 30 | 20 | 0.8972 | 15.78 | 125 | | | |
| 9.485 | 5 | 20 | 8.4817 | 15.78 | 200 | 8.6737 | 2.30% | 0.8113 |
| | 5 | 20 | 8.6589 | 15.78 | 200 | | | |
| | 5 | 20 | 8.8806 | 15.78 | 200 | | | |
| 49.52 | 2 | 19.99 | 49.0147 | 15.78 | 400 | 48.6218 | 0.77% | 0.8982 |
| | 2 | 20 | 48.5862 | 15.78 | 400 | | | |
| | 2 | 19.99 | 48.2644 | 15.78 | 400 | | | |
| 92.08 | 1.2 | 20 | 89.6038 | 15.78 | 500 | 88.2768 | 1.53% | 3.8032 |
| | 1.2 | 20 | 88.3263 | 15.78 | 500 | | | |
| | 1.2 | 20 | 86.9005 | 15.78 | 500 | | | |

The studies above demonstrate that the measurement apparatus is useful for high throughput viscosity measurements. For example, the measurement apparatus reduced total sample measurement time including washing to only three minutes. In addition, non-Newtonian fluids can be measured.

When introducing elements of the present disclosure or the embodiments thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above without departing from the scope of the present disclosure, it is intended that all matter contained in the above description and shown in the accompanying drawings shall be interpreted as illustrative and not in a limiting sense.

1-20. (canceled)

21. An automated method for measuring the viscosity of a plurality of drug samples using a measurement apparatus comprising a positive displacement tip and a capillary, wherein for each drug sample the method comprises:
(a) aspirating a sample volume of about 100 μl or less into the positive displacement tip, the sample volume comprising a pre-fill portion and a remaining portion;
(b) injecting the pre-fill portion of the sample volume from the positive displacement tip into a capillary of the measurement apparatus at a minimum flow rate;
(c) measuring a pre-fill pressure of the pre-fill portion of the sample volume;
(d) calculating a flow rate of the remaining portion of the sample volume based on the measured pre-fill pressure;
(e) injecting the remaining portion of the sample volume from the positive displacement tip into the capillary when the measured pre-fill pressure is less than a predetermined maximum pressure, wherein injecting is performed
(i) at a predetermined maximum flow rate when the calculated flow rate is greater than the predetermined maximum flow rate; or
(ii) at the calculated flow rate when the calculated flow rate is less than the predetermined maximum flow rate;
(f) measuring the pressure of the remaining portion of the sample volume as the remaining portion flows through the capillary;
(g) measuring the viscosity of the remaining portion based on the measured pressure;
(h) cleaning the capillary using an automated wash system; and
(i) repeating steps (a)-(h),
wherein at least steps (c)-(g) are performed while maintaining the temperature of the sample volume between about 4° C. and 40° C.
